(19) United States
(12) Patent Application Publication
(10) Pub. No.: US 2023/0206183 A1
(43) Pub. Date: Jun. 29, 2023

(54) Systems and Methods for Crowd-Sourced Compensation Ranging

(71) Applicant: Payscale, Seattle, WA (US)

(72) Inventors: Sean Harrington, Kirkland, WA (US); Casey Herron, Seattle, WA (US); Neal Dawson-Elli, Redmond, WA (US); James Dunning, Bothell, WA (US); Krista Steuben, Seattle, WA (US); Stefano DiFabio, Danvers, MA (US)

(73) Assignee: Payscale, Seattle, WA (US)

(21) Appl. No.: 18/085,877

(22) Filed: Dec. 21, 2022

Related U.S. Application Data
(60) Provisional application No. 63/294,250, filed on Dec. 28, 2021.

(51) Int. Cl. G06Q 10/1053

(52) U.S. Cl. CPC G06Q 10/1053

(57) ABSTRACT

A method for crowd-sourced compensation ranging is provided, the method including, at least, inclusion, analysis and application of a wide variety of available compensable factors, including one or more crowd-sourced compensable factors.

### CROSS-REFERENCES TO RELATED APPLICATIONS

This patent application claims benefit of U.S. patent application Ser. No. 63/294,250, filed Dec. 28, 2021, the contents of which are hereby incorporated by reference in their entirety.

### FIELD

The present invention is drawn generally to systems and methods for crowd-sourced compensation ranging, and in particular, though non-limiting, embodiments to systems and methods comprising inclusion, analysis and application of a wide variety of available compensable factors, including a plurality of crowd-sourced compensable factors.

### SUMMARY

The compensation systems and methods disclosed herein create prospective pay distribution models based on a plurality of available compensable factors, thereby providing a “snapshot” (or a point-in-time value) of the market for a specific job profile.

A wide variety of systems and methods for crowd-sourced compensation ranging are proposed, comprising one or more of a plurality of pre-defined and/or integrated compensable factors deemed especially relevant to the objects of the present disclosure. In accord with the many objects of the invention, a non-exhaustive but strongly representative list of such factors further comprises commonly associated compensable factors such as job title and location (whether physical or remote), and defined but ultimately innumerable other relevant, crowd-sourced compensable factors as described in greater detail below.

### DETAILED DESCRIPTION

By incorporating, analyzing and integrating consideration of a wide variety of compensation factors, the instant invention provides crowd-sourced compensation ranges including base pay, bonus, and total yearly compensation. The reports provide candidate job titles and prospective employment locations (whether physical or remote), and include consideration of one or more other relevant, compensable factors such as the candidate's skills; certifications, years of experience; education level; industry; company type; company size; management role(s); and whether the candidate is suitable to fulfill a government contractor position. In short, the disclosed compensation model creates a pay distribution range based on all available, relevant compensable factors provided, thereby providing the user a snapshot of the market for a specific job profile.

In one embodiment, the model uses a combination of different machine learning algorithms to determine compensation ranging. For example, a Bayesian linear regression model will predict a dynamic, integrative compensation range for a given job title based on the different compensable factor values provided. This model uses a novel classification system to group skills and certifications for a given job title into different categories such as core (assumed for the role), relevant (specific to a certain function/industry) and premium (commanding higher compensation) categories. This categorization is based on the relative commonness of a skill/certification within a specific job title as compared to the overall labor market.

A second model, a Bayesian hierarchical smoothing model, identifies when the Bayesian linear regression model has extrapolated too far beyond the data's predictive accuracy, thereby providing an additional quality assurance check.

According to one particular embodiment, the structure of the compensation model is practiced a follows:
Data Acquisition: A plurality of crowd-sourced profiles from the last 2 years are extracted from a data warehouse.
Preprocessing: The acquired raw profiles are then cleaned by removing known erroneous compensable factor values.
Outlier detection: Profiles with compensation values that fall outside the expected range are removed from the dataset.
Feature engineering: Various transformations are then applied to the input features (compensable factors) for use in the model.
   Examples include:
   Missing values are replaced using different statistical imputation strategies; and
   Skills and certifications are classified into core/relevant/premium categories.
Training: A separate model is trained for each job title on a set of profiles with the same title.
Evaluation: The performance history and characteristics of each trained model is then evaluated on a set of hold-out/test profiles to measure how closely each model's predicted salaries were to the actual reported values.

Though the present invention disclosed herein is described with respect to several exemplary embodiments, those of ordinary skill in the art will readily appreciate that minor changes to the description, and various other modifications, omissions and additions can also be made without departing from either the spirit or scope thereof.

1. A method for crowd-sourced compensation ranging, and in particular, said method comprising inclusion, analysis and application of a plurality of available compensable factors, including a plurality of crowd-sourced compensable factors.
